(19) United States
(12) Patent Application Publication
(10) Pub. No.: US 2018/0045550 A1
(43) Pub. Date: Feb. 15, 2018

(54) CAPACITIVE LIQUID LEVEL MEASUREMENT

(71) Applicant: TEXAS INSTRUMENTS INCORPORATED, Dallas, TX (US)

(72) Inventors: Luke LaPointe, San Jose, CA (US); Yibo Yu, Santa Clara, CA (US)

(21) Appl. No.: 15/657,104

(22) Filed: Jul. 21, 2017

Related U.S. Application Data
(60) Provisional application No. 62/365,377, filed on Jul. 21, 2016.

(51) Int. Cl. G01F 23/26

(52) U.S. Cl. CPC G01F 23/263

(57) ABSTRACT

A system for capacitive liquid level measurement of liquid in a container, including a level sensor with level+ and level− electrodes, driven out-of-phase to project a sensing electric field into the container, and a reference sensor with ref+ and ref− electrodes, driven out-of-phase to project a sensing electric field into the container. Sensor electronics drives the level sensor electrodes level+/− and the reference sensor electrodes ref+/− out of phase to project respective level and reference capacitance sensing fields into the container, and acquires respective level and reference capacitance measurements from the level and reference sensors. The level and reference capacitance measurement are converted into data representative of liquid level in the container. The level and reference capacitance measurements can be differentially converted according to: Liquid Level=(h_{L}−h_{R}) [MEAS1/MEAS1(h_{L})]+h_{R}, where MEAS1=Cin1−Cin2.

### CROSS-REFERENCE TO RELATED APPLICATIONS

Priority is claimed under 37 CFR 1.78 and 35 USC 119(e) to U.S. Provisional Application 62/365,377 (Docket TI-77557P5), filed 2016 Jul. 21), which is incorporated by reference.

### BACKGROUND

### Technical Field

This patent Disclosure relates to capacitive sensing, and more particularly to capacitive sensing for liquid levels.

### Related Art

Capacitive sensing for liquid level measurement height within containers can be based on projected capacitance in which a driven capacitive sensor projects an electric sensing field into a liquid container, through a liquid. Liquid level can be sensed by measuring the fringing capacitance between a liquid level electrode and a ground or other electrode (the dual electrodes forming a capacitive sensor), dimensioned according to a predetermine liquid level range.

The fringing capacitance is a function of the dielectric liquid/air variation, and is proportional to liquid height. That is, ignoring environmental factors, such as parasitic capacitances, measured capacitance decreases linearly as liquid level decreases (such as from a calibrated maximum).

### BRIEF SUMMARY

This Brief Summary is provided as a general introduction to the Disclosure provided by the Detailed Description and Drawings, summarizing aspects and features of the Disclosure. It is not a complete overview of the Disclosure, and should not be interpreted as identifying key elements or features of, or otherwise characterizing or delimiting the scope of, the disclosed invention.

The Disclosure describes apparatus and methods for capacitive liquid level measurement.

According to aspects of the Disclosure, a system for capacitive liquid level measurement of liquid in a container includes a level sensor with level+ and level− electrodes, driven out-of-phase to project a sensing electric field into the container, and a reference sensor with ref+ and ref− electrodes, driven out-of-phase to project a sensing electric field into the container. Sensor electronics drives the level sensor electrodes level+/− and the reference sensor electrodes ref+/− out of phase to project respective level and reference capacitance sensing fields into the container, and acquires respective level and reference capacitance measurements from the level and reference sensors. The level and reference capacitance measurement are converted into data representative of liquid level in the container. The level and reference capacitance measurements can be differentially converted according to: Liquid Level=(h_{L}−h_{R}) [MEAS1/MEAS1(h_{L})]+h_{R}, where MEAS1=Cin1−Cin2.

Other aspects and features of the invention claimed in this Patent Document will be apparent to those skilled in the art from the following Disclosure.

### BRIEF DESCRIPTION OF THE DRAWINGS

### Color Drawings

This patent Disclosure contains at least one drawing in color. Copies of this Provisional patent Disclosure with color drawings will be provided by the Office upon request and payment of the necessary fee.

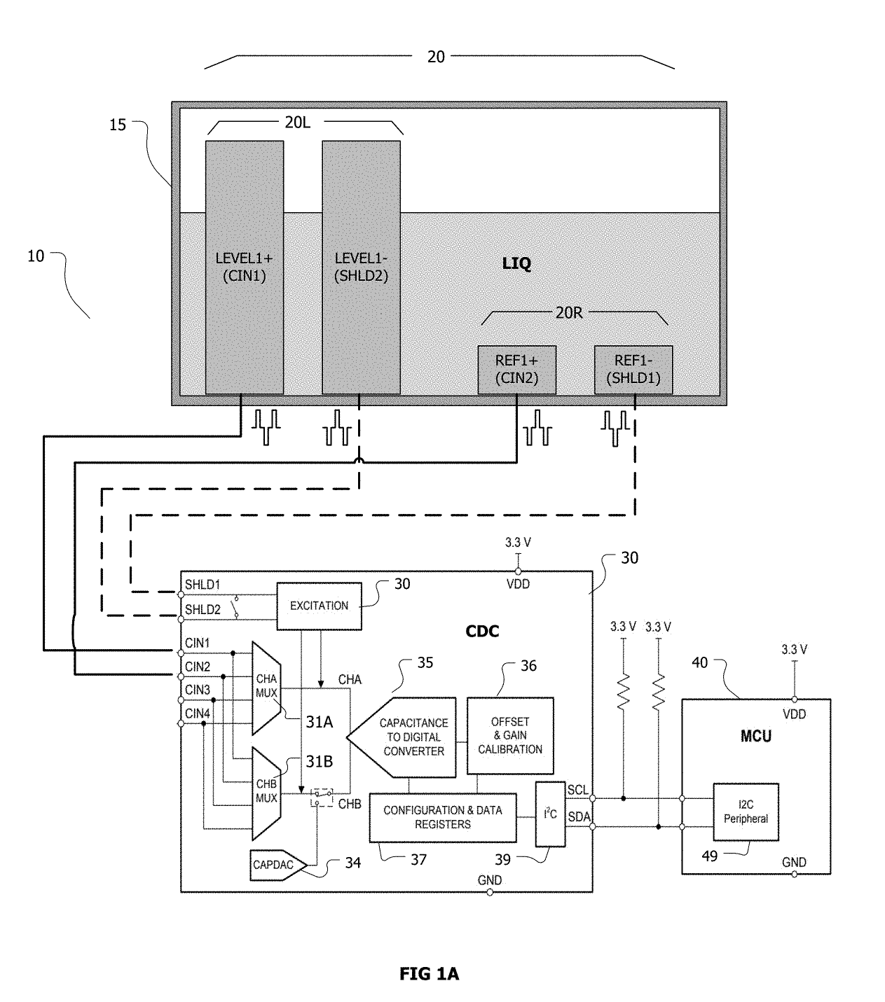

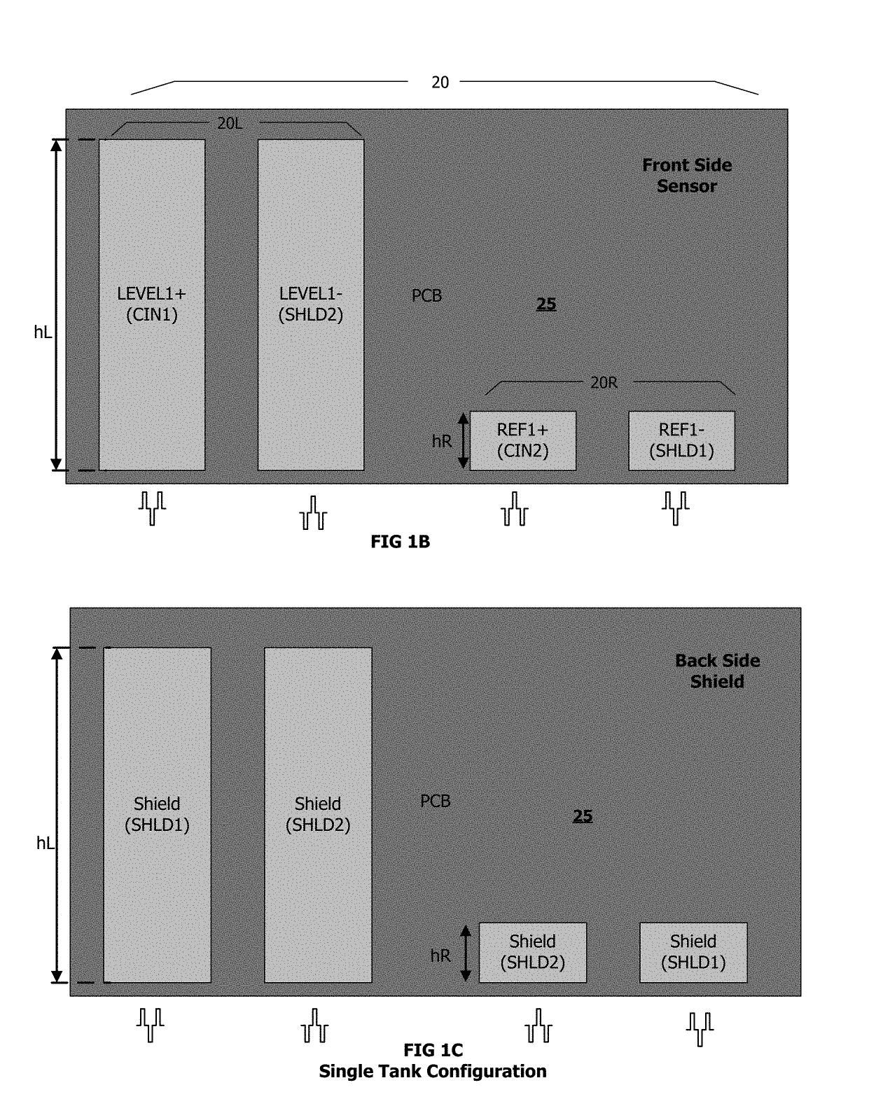

FIG. 1A illustrate an example capacitive liquid level measurement system [10] with a single tank [15], and including a differential sensor/electrode configuration [20], with LEVEL [20L] and REF (reference) [20R] sensors, and sensor electronics (CDC) 30.

FIGS. 1B-1C illustrate an example sensor electrode PCB: FIG. 1B illustrates a PCB front side with a differential sensor electrode configuration [20] with LEVEL [20L] and REF [20R] sensors; and FIG. 1C illustrates a PCB back side with SHLD (shield) electrodes.

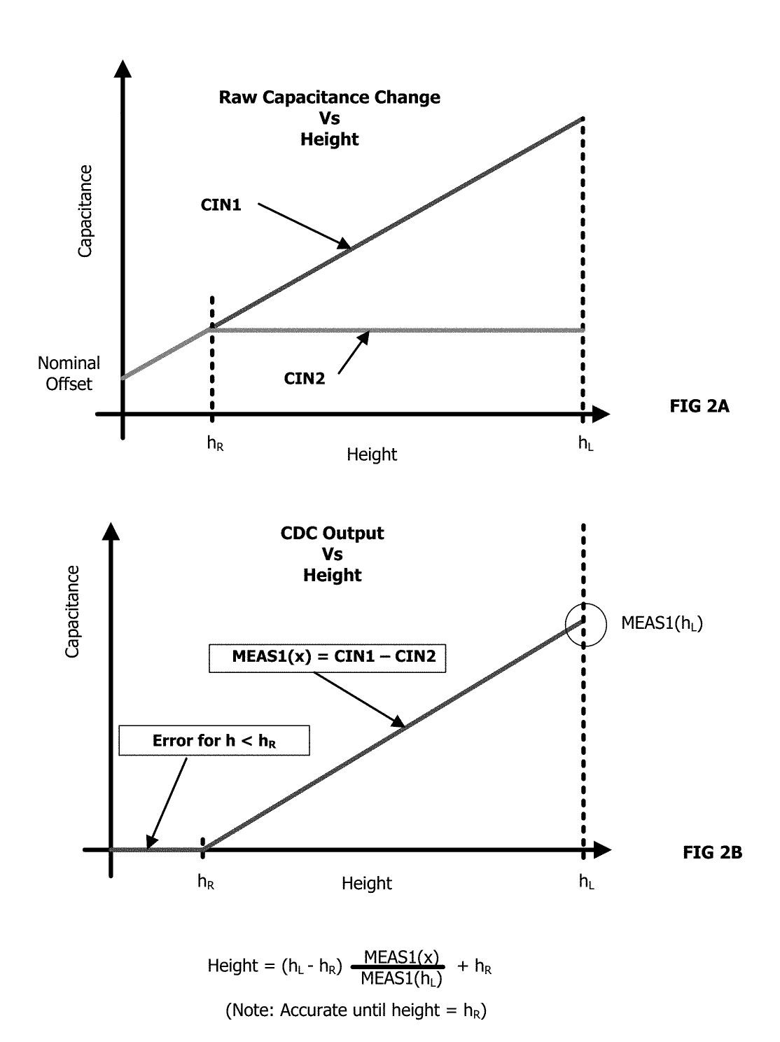

FIGS. 2A-2B illustrate example plots for: (FIG. 2A) Raw Ca[acutance Change with Height; and (FIG. 2B) CDC Sensor Output [MEAS1(x)=CIN1−CIN2].

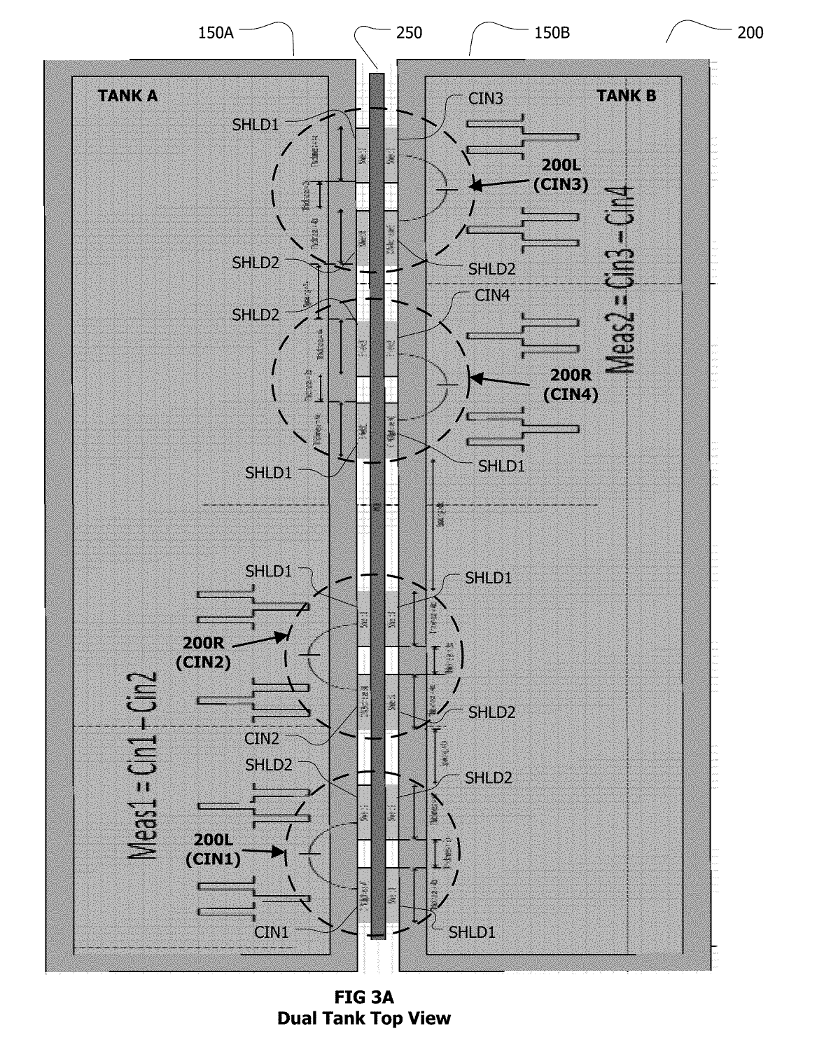

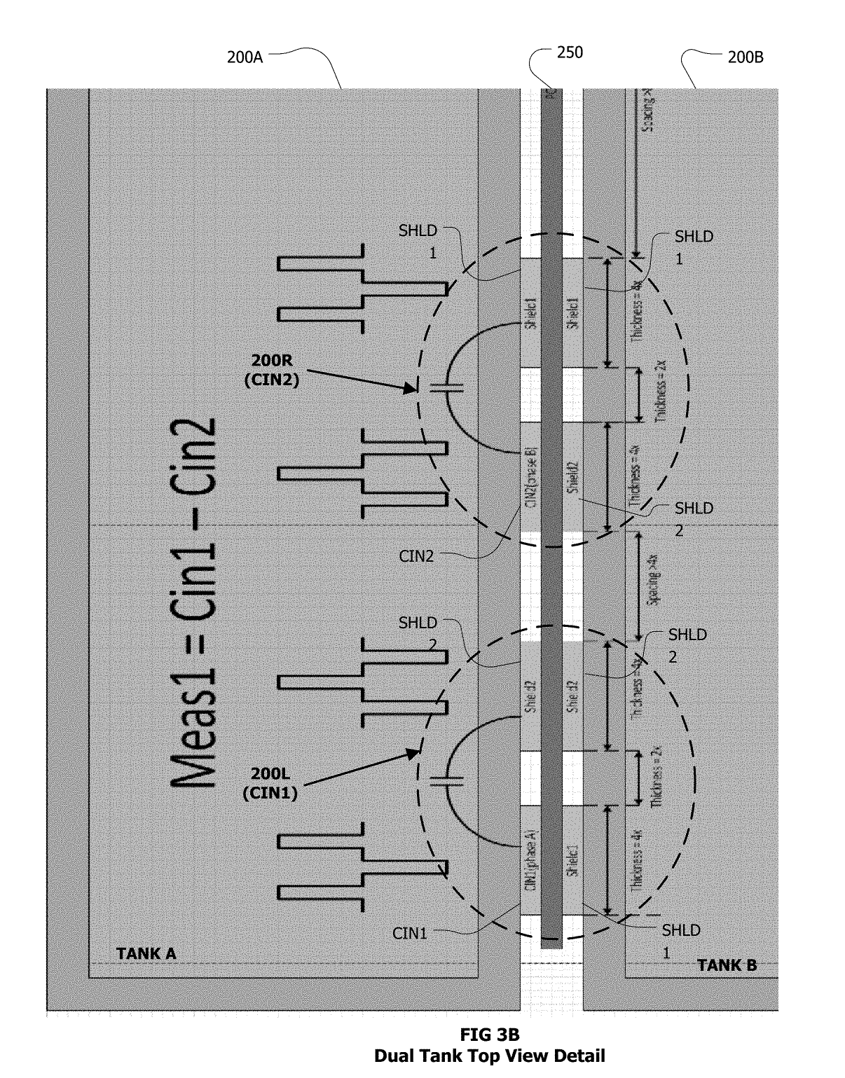

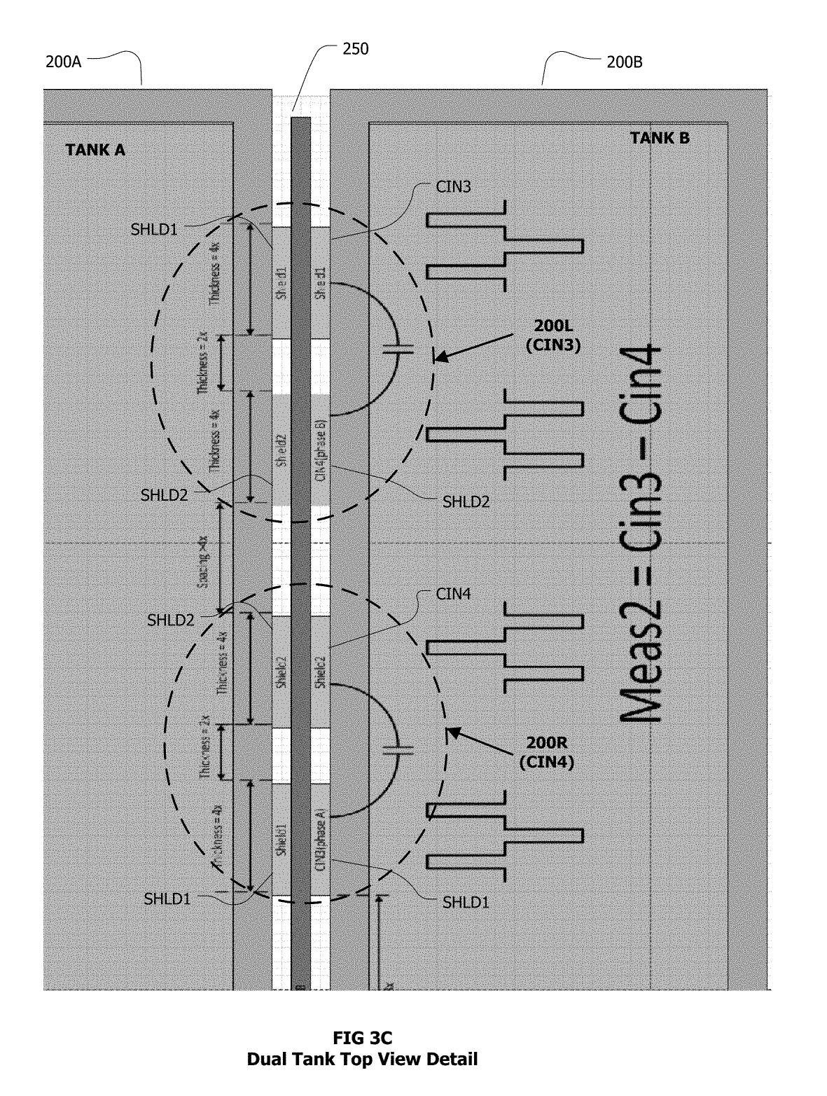

FIGS. 3A-3C illustrate an example dual-tank [150A, 150B] capacitive liquid level measurement sensor configuration [200], with a single PCB [250] disposed between the two tanks: FIG. 3A illustrates a top view of the dual tank configuration [200], including the PCB Tank A side with differential Level/Reference capacitive sensors [200L/200R, CIN1/CIN2] for Tank A [150A], and the PCB Tank B side with differential Level/Reference capacitive sensors [200L/200R, CIN3, CIN4] for Tank B [150B], and with the shields for each sensor [SHLD 1/2] on the opposite side of the PCB; FIGS. 3B-3C illustrate detail for respectively the differential Level/Reference capacitive sensors [200L/200R, CIN1/CIN2], and the differential Level/Reference capacitive sensors [200L/200R, CIN3, CIN4].

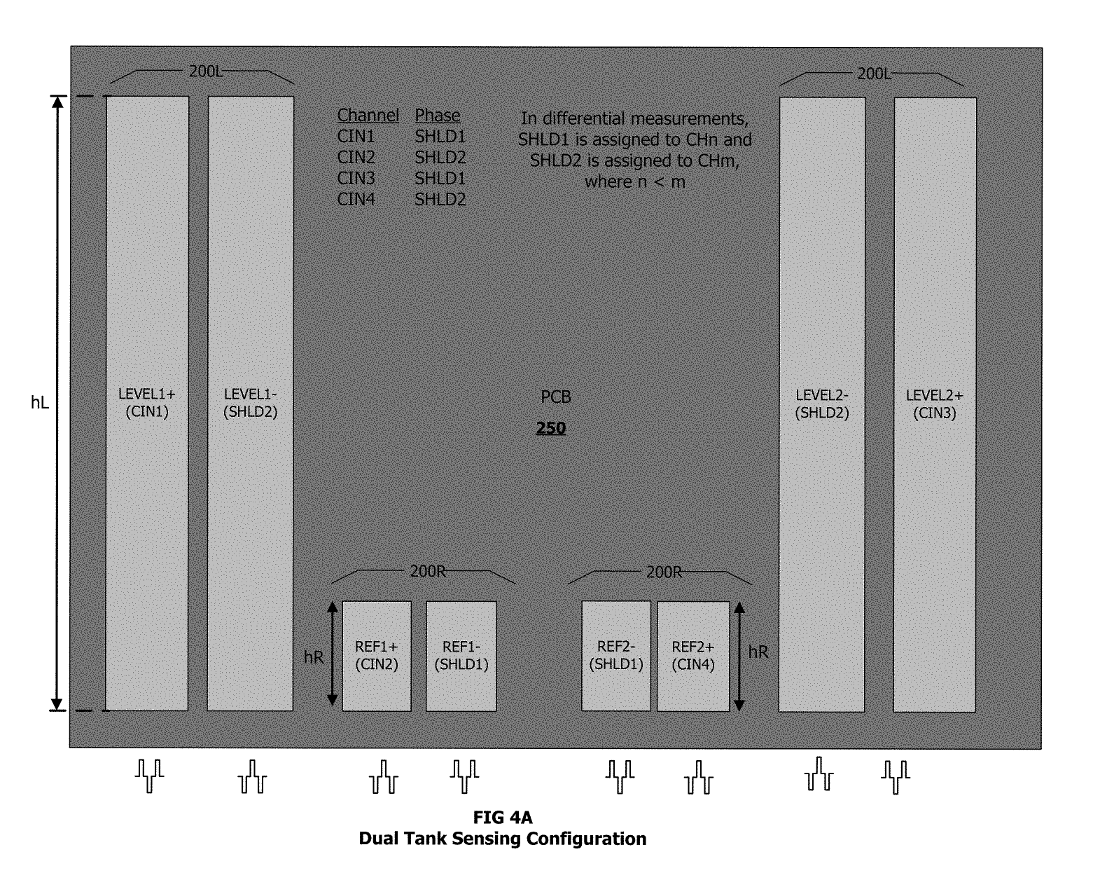

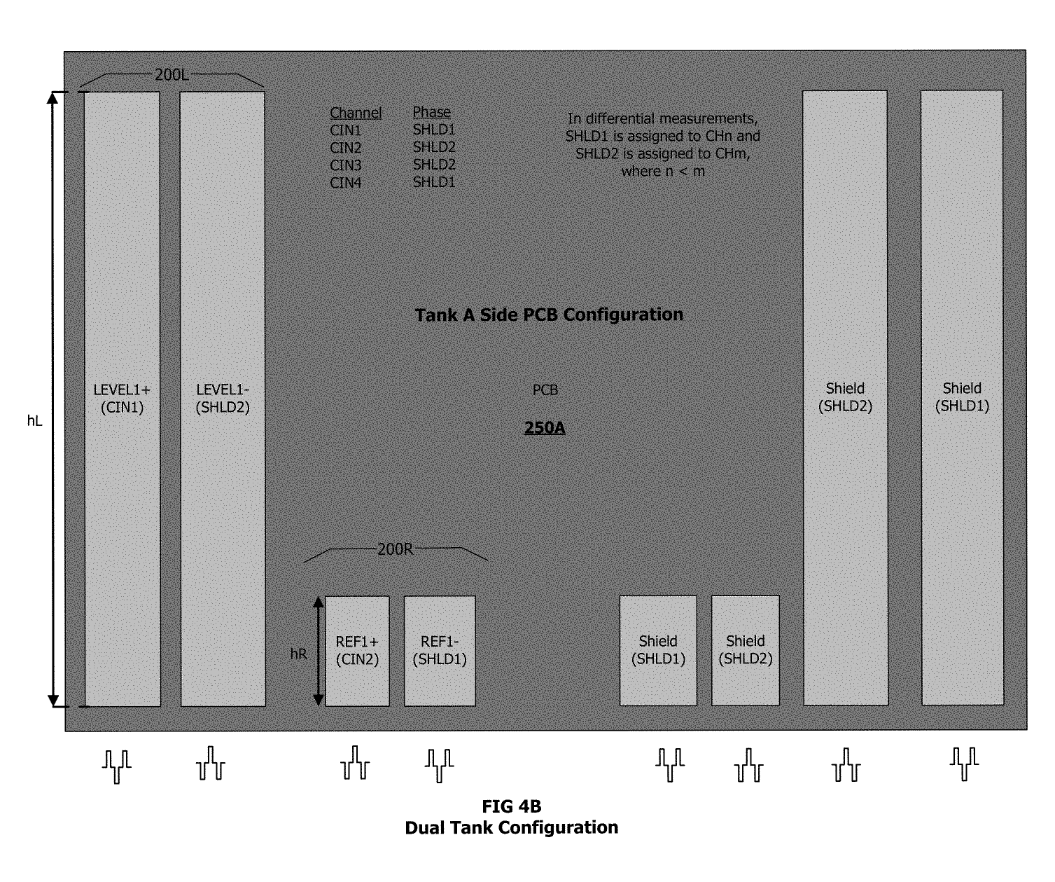

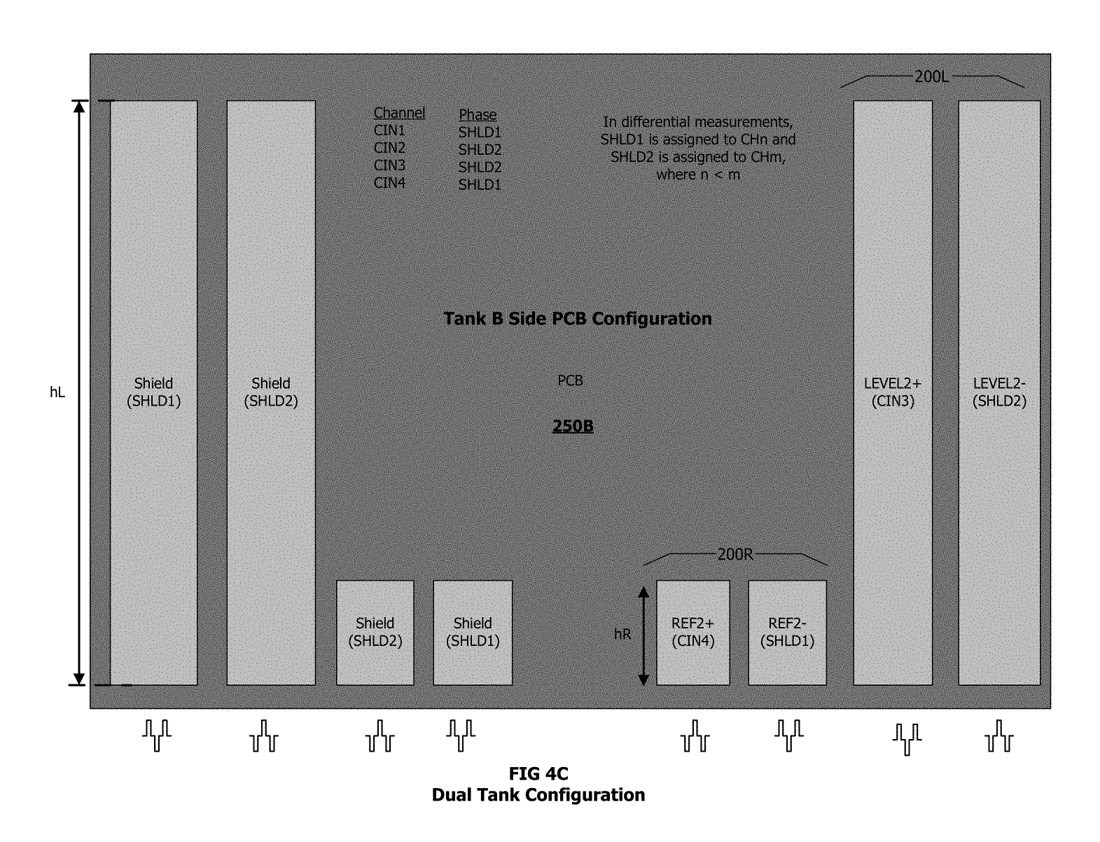

FIGS. 4A-4B illustrate the example dual-tank PCB configuration [250]: FIG. 4A is a functional representation of both differential sensors [200L/200R], including illustrating drive phases for the sensor electrodes configured to suppress capacitance between sensors (i.e., between the LEVEL and REF Sensors [200L/200R], and between adjacent Tank A/B REF Sensors; FIG. 4B illustrates the Tank A side of the PCB configuration, including Tank A differential sensors [200L200R], and the shields [SHLD 1/2] for the Tank B differential sensors; and FIG. 4C illustrates the Tank B side of the PCB configuration, including Tank B differential sensors [200L/200R], and the shields for the Tank A differential sensors [SHLD 1/2].

### DETAILED DESCRIPTION

This Description and the Drawings constitute a Disclosure for capacitive liquid level measurement, including describing examples, and various technical features and advantages.

In brief overview, a system for capacitive liquid level measurement of liquid in a container, including a level sensor with level+ and level− electrodes, driven out-of-phase to project a sensing electric field into the container, and a reference sensor with ref+ and ref− electrodes, driven out-of-phase to project a sensing electric field into the container. Sensor electronics drives the level sensor electrodes level+/− and the reference sensor electrodes ref+/− out of phase to project respective level and reference capacitance sensing fields into the container, and acquires respective level and reference capacitance measurements from the level and reference sensors. The level and reference capacitance measurement are converted into data representative of liquid level in the container. The level and reference capacitance measurements can be differentially converted according to: Liquid Level=(h_{L}−h_{R}) [MEAS1/MEAS1(h_{L})]+h_{R}, where MEAS1=Cin1−Cin2. For a dual side-by-side implementation with adjacent first and second container, a printed circuit board (PCB) disposed between the first and second containers, the PCB including a first PCB side adjacent the first container, and a second PCB side adjacent the second container, the first PCB side including differential level and reference sensors for the first tank, and the second PCB side including differential level and reference sensors for the second tank.

FIG. 1A illustrate an example capacitive liquid level measurement system 10 with a single tank 15, and including a differential sensor/electrode configuration 20, and sensor electronics (CDC) 30.

The differential sensor configuration includes LEVEL sensor 20L and REF (reference) sensor 20R. LEVEL sensor 20L includes electrodes LEVEL1+ (CIN1) and LEVEL1− (SHLD2), which are driven out-of-phase. REF sensor 20R includes electrodes REF1+ (CIN2) and REF1− (SHLD1), which are driven out of phase. Note that the LEVEL1− electrode (SHLD2) of LEVEL sensor 20L and the REF1+electrode (CIN2) of the REF sensor 20R are driven with the same phase, suppressing any capacitance between the LEVEL and REF sensors.

Capacitive sensor electronics is implemented as a capacitance-to-data converter (CDC) 30. Capacitive liquid level sensing according to this Disclosure is based on projected capacitance in which driven capacitive sensors project an electric sensing field into tank 15, and measured capacitance changes substantially linearly with liquid level, for example linearly decreasing as liquid level decreases.

This Disclosure uses nomenclature for the sensors 20, LEVEL and REF sensors 20L/20R, that conforms to nomenclature used for the example CDC 30. CDC 30 includes four capacitance acquisition/measurement channels CIN1-CIN4, and two shield driver outputs SHLD1-SHLD2. CDC 30 drives out dual phase (A and B) excitation signals through CIN1-CIN4 and SHLD1-SHLD2 ports. The CIN1-CIN4 and SHLD1-SHLD2 terminals are coupled to respective electrodes of the differential LEVEL/REF sensors, including driving respective LEVEL+/LEVEL− and REF+/REF− electrodes out-of-phase.

CDC unit 30 implements capacitance-to-digital conversion, with capacitance acquisition of differential LEVEL/REF sensor capacitance measurements, and conversion to sensor capacitance data corresponding to vascular pulsation. For each sensor, capacitance is measured between CINx and the associated SHLD1/SHLD2 electrode. The CINx channel inputs are multiplexed by channel multiplexers 31A/B into dual acquisition/measurement channels CHA/CHB. CDC 30 is configurable for single-ended (CHA) or differential (CHA/CHB) capacitance measurement, with differential CHA/CHB capacitance measurement used for liquid level sensing according to this Disclosure.

CDC 30 implements capacitance acquisition/measurement based on multi-phase capacitive charge transfer, such as with a switched capacitor configuration. Excitation block 35 is configured to provide sensor excitation and shield drive. Sensor excitation is provided at a specified excitation frequency for capacitive charge transfer (with excitation/charging and transfer/discharging phases). Shield drive can be provided synchronously with sensor excitation frequency, and can be used to focus sensing direction, and to counteract CINx parasitic capacitance.

Sensor excitation at the excitation frequency generates a sensor E-field between the sensor electrodes. During the excitation/charging phase, a sense voltage is applied to CINx, charging the sensor electrode. During the transfer/discharging phase the sensor electrode is discharged into a designated acquisition channel CHA/CHB, transferring charge that is a measure of the self-capacitance of the capacitive sensor.

CAPDAC 354 can be used to balance common-mode or offset capacitance for single-ended operation, but is disabled for differential operation, such as for liquid level sensing according to this Disclosure.

CDC 30 includes a capacitance-to-digital converter 35, offset and gain calibration 356, and configuration and data registers 357.

Converter 355 performs capacitance acquisition and data conversion. Converter 355 measures CHA/CHB input/acquisition capacitance, subject to CAPDAC offset, based on analog charge transfer. Specifically, sensor capacitance measurements are acquired through phased charge transfer, such as with a switched capacitor arrangement. Converter 35 performs analog-to-digital conversion, converting the sensor self-capacitance measurements into digital data, such as with a sigma delta converter. Configuration and Data Registers 37 includes data registers used in conjunction with capacitance capture (acquisition/conversion) by converter 35.

Offset and gain calibration 36 can provide offset calibration coefficient(s) for parasitic capacitance offset calibration, which can be combined with offset provided by the on-chip CAPDACs 34, and gain calibration used to normalize capacitance measurements of the CINx input channels based on stored gain coefficient(s). Configuration and Data Registers 357 includes configuration registers that store configuration values for offset/gain calibration. Offset registers can store digitized capacitance values which can be added to each channel to remove parasitic capacitance due to external circuitry, including tuning offset capacitance provided by CAPDACs 354. Gain registers can store gain factor correction (for example, in the range of 0 to 4) which can be applied to each channel in order to remove gain mismatch due to external circuitry.

CDC 30 can be configured for interfacing to a single-ended, or dual differential capacitive sensors. For differential configurations, interfaced to a differential capacitive sensor such as the LEVEL/REF sensor configuration used for liquid level measurement according to this Disclosure, CDC 30 measures differential, unbalanced capacitance at CINx within the input capacitance range. In this configuration the SHLD1 signal operates with CHA, and the SHLD2 signal operates with CHB.

CDC 30 can be configured to support two modes of operation, single acquisition and repeated acquisition. In single acquisition mode, only one capacitance acquisition/measurement is enabled. CDC 30 is configured for appropriate acquisition parameters (repeat bit=0, and, for example, sample rate and notch filter), and an acquisition is performed by capturing the capacitance measurement, storing the result in a register and setting a measurement-done bit. In repeated acquisition mode, CDC 350 performs cycled acquisitions. CDC 30 is configured for appropriate acquisition parameters (repeat bit=1 and repeat value, and, for example, sample rate, notch filter), and an acquisition is performed by capturing the designated number of capacitance measurements, storing the results in a register and setting a measurement-done bit. Cycled acquisition remains on until the repeat bit is set to “0”.

Results can be transferred to an MCU (data processor) 40 in a read operation. The results in the capacitance measurement registers 37 can be cyclically updated even if the registers are not read. CDC 30 can be interfaced to an MCU processor 37 through an I2C interface. Sensor data captured into data registers 37 is output to the MCU processor 40, for processing liquid level measurements.

FIGS. 1B-1C illustrate an example sensor electrode PCB. FIG. 1B illustrates a PCB front side with a differential sensor electrode configuration [20] with LEVEL [20L] and REF [20R] sensors. FIG. 1C illustrates a PCB back side with SHLD (shield) electrodes.

FIGS. 2A-2B illustrate example plots for the capacitive liquid level sensing system. FIG. 2A illustrates Raw Capacitance Change with Height. FIG. 2B illustrates CDC Sensor Output [MEAS1(x)=CIN1−CIN2], starting from a tank-full calibration value [MEAS(h_{L}).

FIG. 3A illustrates an example dual-tank 150A, 150B capacitive liquid level measurement sensor configuration 200, with a single PCB 250 disposed between the two tanks. A PCB Tank A side includes differential Level/Reference capacitive sensors 200L/200R (CIN1/CIN2) for Tank A 150A, and the PCB Tank B side includes differential Level/Reference capacitive sensors 200L/200R (CIN3, CIN4) for Tank B 150B. The shields for each sensor SHLD 1/2 are on the opposite side of the PCB.

FIGS. 3B-3C provides detail for the differential capacitive sensors CIN1/CIN2 and CIN3/CIN4. FIG. 3B provides detail for the differential Level/Reference capacitive sensors 200L/200R, with respectively capacitive electrodes CIN1 (Level) and CIN2 (Reference). FIG. 3C provides detail for differential Level/Reference capacitive sensors 200L/200R, with respectively capacitive electrodes CIN3 (Level) and CIN4 (Reference).

FIGS. 4A-4B illustrate the example dual-tank PCB configuration 250. FIG. 4A is a functional representation of both differential sensors [200L/200R], including illustrating drive phases for the sensor electrodes configured to suppress capacitance between sensors (i.e., between the LEVEL and REF Sensors 200L/200R, and between adjacent Tank A/B REF Sensors. FIG. 4B illustrates the Tank A side of the PCB configuration, including Tank A differential sensors 200L200R, and the shields SHLD 1/2 for the Tank B differential sensors. FIG. 4C illustrates the Tank B side of the PCB configuration, including Tank B differential sensors 200L/200R, and the shields for the Tank A differential sensors SHLD 1/2.

The Disclosure provided by this Description and the Figures sets forth examples and applications illustrating aspects and features of the invention, and does not limit the scope of the invention, which is defined by the claims. Known circuits, connections, functions and operations are not described in detail to avoid obscuring the principles and features of the invention. These example embodiments and applications, can be used by ordinarily skilled artisans as a basis for modifications, substitutions and alternatives to construct other embodiments, including adaptations for other applications.

1. A system for capacitive liquid level measurement, comprising:
a container with liquid;
a level sensor with level+ and level− electrodes, driven out-of-phase to project a sensing electric field into the container;
a reference sensor with ref+ and ref− electrodes, driven out-of-phase to project a sensing electric field into the container;
sensor electronics to
drive the level sensor electrodes level+/− and the reference sensor electrodes ref+/− out of phase to project respective level and reference capacitance sensing fields into the container, and
acquire respective level and reference capacitance measurements from the level and reference sensors, and
differentially convert the level and reference capacitance measurements into data representative of liquid level in the container.

2. The system of claim 1, wherein the level and reference capacitance measurements are differentially converted according to: Liquid Level=(h_{L}−h_{R}) [MEAS1/MEAS1(h_{L})]+h_{R}, where MEAS1=Cin1−Cin2.

3. The system of claim 1, wherein the container comprises a first container, and further comprising:
a second container disposed adjacent the first container;
a printed circuit board (PCB) disposed between the first and second containers;
the PCB including a first PCB side adjacent the first container, and a second PCB side adjacent the second container;
the first PCB side including differential level and reference sensors for the first tank, and
the second PCB side including differential level and reference sensors for the second tank.
